(19) United States
(12) Patent Application Publication
(10) Pub. No.: US 2014/0254788 A1
(43) Pub. Date: Sep. 11, 2014

(54) COMMUNICATION BETWEEN A MOBILE DEVICE AND A CALL CENTER

(71) Applicant: BANK OF AMERICA CORPORATION, Charlotte, NC (US)

(72) Inventors: Vidya S. Annapareddy, Roseville, CA (US); Seth E. Clark, Charlotte, NC (US); Jun Ma, Princeton, NJ (US); Brian J. Nacey, Charlotte, NC (US)

(73) Assignee: Bank of America Corporation, Charlotte, NC (US)

(21) Appl. No.: 13/793,728

(22) Filed: Mar. 11, 2013

(51) Int. Cl. H04M 3/51

(52) U.S. Cl. CPC H04M 3/5183
USPC 379/265.09

(57) ABSTRACT

According to certain embodiments of the disclosure, a processor determines whether an application is launched on a mobile device. The application is stored locally on the mobile device. When the application is launched on the mobile device, a unique identifier associated with a session of the application launched on the mobile device is generated. User interactions with the application are captured during the session and associated with the unique identifier.

### TECHNICAL FIELD OF THE INVENTION

This invention relates generally to communication techniques, and more particularly to communication between a mobile device and a call center.

### BACKGROUND

Organizations may provide support services for their customers. Certain organizations use a call center environment to handle questions from the customers, to resolve customer issues, and to provide the support services. When a customer has an issue on which it contacts the call center, it may be difficult for the call center agent to fully understand the issue presented by the customer.

### SUMMARY

According to embodiments of the present disclosure, disadvantages and problems associated with communication between a mobile device and a call center may be reduced or eliminated.

In certain embodiments, a processor determines whether an application is launched on a mobile device. The application is stored locally on the mobile device. When the application is launched on the mobile device, a unique identifier associated with a session of the application launched on the mobile device is generated. User interactions with the application are captured during the session and associated with the unique identifier.

Certain embodiments of the present disclosure may provide one or more technical advantages. A technical advantage of one embodiment includes gathering data regarding a customer's usage of a mobile application to determine potential issues the customer may encounter and proactively engage with the customer to remedy the issue. Another technical advantage of an embodiment includes providing an active view of the customer's interactions with a mobile application to a call center agent with during a support session. By providing the active view to the call center agent during the session, the call center agent is able to more readily appreciate the customer's issue and determine an appropriate resolution. Yet another technical advantage of an embodiment includes configuring the system to log only certain portions of information related to the user interactions.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of a system for facilitating communication between a mobile device and a call center;

FIG. 2 illustrates an example flowchart for facilitating communication between a mobile device and a call center in a passive mode; and

FIG. 3 illustrates an example flowchart for facilitating communication between a mobile device and a call center in an active mode.

### DETAILED DESCRIPTION OF THE DRAWINGS

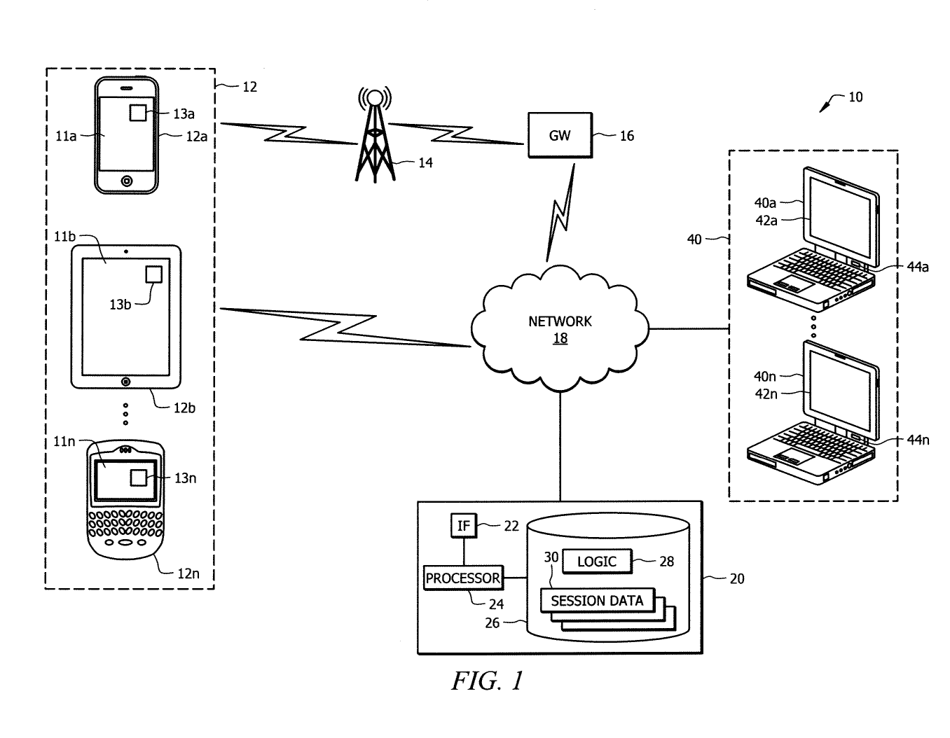

Embodiments of the present invention and its advantages are best understood by referring to FIGS. 1 through 3 of the drawings, like numerals being used for like and corresponding parts of the various drawings.

Organizations may provide support services for their customers. Certain organizations use a call center environment to handle questions from the customers, to resolve customer issues, and to provide the support services. When a customer has an issue on which it contacts the call center, it may be difficult for the call center agent to fully understand the issue presented by the customer. According to the described embodiments, a system is disclosed that facilitates the communication between a mobile device and a call center. By facilitating this communication, a call center agent may actively view a customer's mobile device during a support session to improve the quality of the support provided to the customer. Additionally, by capturing and storing user interactions with a mobile application, the call center may proactively improve the provision of services to the customer and improve the user's experience with the mobile application.

FIG. 1 illustrates a block diagram of a system for facilitating communication between a mobile device and a call center. System 10 includes mobile devices 12 that communicate with base station 14 and gateway 16 to provide information regarding a user's interactions with an application to logging module 20. Logging module 20 may communicate the interactions to call center devices 40 for display.

System 10 includes mobile devices 12a-12n, where n represents any suitable number, that communicate user interactions to logging module 20 through base station 14, gateway 16, and network 18. In an embodiment, a user interacts with an application 13 using mobile device 12. User interactions, which may be referred to as inputs or actions, may include orientation changes, swipes, taps, double taps, or any other suitable input or action that a user may take when interacting with mobile device 12 or interacting with an application 13 launched on mobile device 12. While the user interacts with application 13, after a user concludes working with application 13, or at any other suitable time, mobile device 12 communicates the user interactions to logging module 20. Examples of mobile device 12 include a mobile phone, a personal digital assistant, a portable media player (e.g., portable video player, digital audio player, etc.), a laptop, a netbook, a Ultrabook™, a tablet, and any other suitable device. Mobile device 12 may be compatible with any suitable platform or operating system. For example, mobile device 12 may include an Android™ device, an Apple® device, a Windows® device, a BlackBerry® device, or any other suitable mobile device. Mobile device 12 includes any necessary hardware and software suitable to carry out its functions. In an embodiment, mobile device 12 includes a memory that stores user interactions for communication to logging module 20. Certain embodiments of mobile device 12 include a graphical user interface (GUI) 11 and application 13.

In the illustrated embodiment, mobile device 12 includes a GUI 11 that displays information from application 13 to a user to facilitate a user's interactions with application 13. For example, GUI 11 may display a login screen for a user to provide login credentials to access information using application 13. GUI 11 is generally operable to tailor and filter data entered by and presented to the user. GUI 11 may provide the user with an efficient and user-friendly presentation of information using a plurality of displays having interactive fields, pull-down lists, and buttons operated by the user. GUI 11 may include multiple levels of abstraction including groupings and boundaries. It should be understood that the term GUI 11 may be used in the singular or in the plural to describe one or more GUIs 11 in each of the displays of a particular GUI 11.

Mobile device 12 also includes one or more applications 13. Application 13 represents any suitable software or logic that allows a user to access information, provides information to a user, and/or facilitates interactions between a user and a call center. For example, a user may launch application 13 on mobile device 12, input login credentials into application 13, and gain access to a plurality of financial accounts serviced by the enterprise associated with application 13. When utilizing the various functions of application 13, the user may contact a call center to receive advice, information, or guidance regarding a topic. The described embodiments contemplate communicating, to logging module 20, the user interactions with application 13 on mobile device 12 to facilitate receiving assistance from the call center agent using call center device 40. In an embodiment, application 13 includes a utility library that facilitates the capture of user interactions to communicate to logging module 20. The utility library may also dictate the information that is captured and communicated to logging module 20. For example, utility library may indicate that certain portions of application 13 should be masked and not communicated to logging module 20. An administrator, the user of mobile device 12, or any other suitable entity may change the configuration of application 13. Application 13 may include a native application or a hybrid application stored on mobile device 12.

Base station 14 and gateway 16 represent components that facilitate communication between the components in system 10. While specific components are illustrated, the disclosure contemplates any suitable network operable to facilitate communication between the components of system 10. A network may include any interconnecting system capable of transmitting audio, video, signals, data, messages, or any combination of the preceding. As an example and not by way of limitation, one or more portions of the network, consisting of base station 14 and/or gateway 16, may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of public switched telephone network (PSTN), a cellular telephone network, or a combination of two or more of these.

Network 18 represents any suitable network operable to facilitate communication between the components of system 10, such as mobile devices 12, logging module 20, and call center devices 40. Network 18 may include any interconnecting system capable of transmitting audio, video, signals, data, messages, or any combination of the preceding. Network 18 may include all or a portion of a public switched telephone network (PSTN), a public or private data network, a LAN, a MAN, a WAN, a WWAN, a local, regional, or global communication or computer network, such as the Internet, a wireline or wireless network, an enterprise intranet, or any other suitable communication link, including combinations thereof, operable to facilitate communication between the components.

Logging module 20 represents any suitable component that logs user interactions with application 13, determines the user interactions to communicate to call center device 40, converts the user interactions into a format for display on call center devices 40, and/or communicates the converted user interactions to call center device 40 for display. Logging module 20 may include a network server, any suitable remote server, a mainframe, a host computer, a workstation, a web server, a personal computer, a file server, or any other suitable device operable to communicate with mobile device 12. In some embodiments, logging module 20 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of logging module 20 may be performed by any suitable combination of one or more servers or other components at one or more locations. In the embodiment where logging module 20 is a server, the server may be a private server, or the server may be a virtual or physical server. The server may include one or more servers at the same or remote locations. Also, logging module 20 may include any suitable component that functions as a server. In the illustrated embodiment, logging module 20 includes a network interface 22, a processor 24, and a memory 26.

Network interface 22 represents any suitable device operable to receive information from network 18, transmit information through network 18, perform processing of information, communicate with other devices, or any combination of the preceding. For example, network interface 22 receives user interactions with application 13 from mobile device 12. As another example, network interface 22 communicates the user actions to call center device 40 for display to a call center agent. Network interface 22 represents any port or connection, real or virtual, including any suitable hardware and/or software, including protocol conversion and data processing capabilities, to communicate through a LAN, WAN, or other communication system that allows logging module 20 to exchange information with mobile devices 12, network 18, call center devices 40, or other components of system 10.

Processor 24 communicatively couples to network interface 22 and memory 26, and controls the operation and administration of logging module 20 by processing information received from network interface 22 and memory 26. Processor 24 includes any hardware and/or software that operates to control and process information. For example, processor 24 executes logic 28 to control the operation of logging module 20. Processor 24 may be a programmable logic device, a microcontroller, a microprocessor, any suitable processing device, or any suitable combination of the preceding.

Memory 26 stores, either permanently or temporarily, data, operational software, or other information for processor 24. Memory 26 includes any one or a combination of volatile or non-volatile local or remote devices suitable for storing information. For example, memory 26 may include random access memory (RAM), read only memory (ROM), magnetic storage devices, optical storage devices, or any other suitable information storage device or a combination of these devices. While illustrated as including a particular module, memory 26 may include any suitable information for use in the operation of logging module 20. In the illustrated embodiment, memory 26 includes logic 28 and session data 30.

Logic 28 generally refers to logic, rules, algorithms, code, tables, and/or other suitable instructions embodied in a computer-readable storage medium for performing the described functions and operations of logging module 20. For example, logic 28 facilitates the logging of user interactions from application 13. Logic 28 also facilitates the determination of what data to log from the various user interactions and what data to communicate to call center devices 40 for display.

Session data 30 refers to information received from mobile devices 12 that indicate the user interactions with application 13. Session data 30 may include any combination of data in any suitable format. For example, logging module 20 may receive the user interactions in a plain text format and may store the user interactions as raw data in session data 30.

Call center devices 40a-40n, where n represents any suitable number, communicate with logging module 20 to receive user interactions for display to a cell center agent. The call center agent interacts with call center device 40 to improve the effectiveness and efficiency of support services provided to a user. Call center device 40 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10. A call center agent using call center device 40 may initiate application 44 to review and analyze previously stored user interactions or to view user interactions in real time to provide guidance regarding an issue. Call center device 40 may also comprise a user interface, such as a display, a microphone, keypad, or other appropriate terminal equipment usable by a user.

In the illustrated embodiment, call center device 40 includes a GUI 42 that displays information associated with application 44 and information received from logging module 20. GUI 42 is generally operable to tailor and filter data entered by and presented to the user. GUI 42 may provide the user with an efficient and user-friendly presentation of information using a plurality of displays having interactive fields, pull-down lists, and buttons operated by the user. GUI 42 may include multiple levels of abstraction including groupings and boundaries. It should be understood that the term GUI 42 may be used in the singular or in the plural to describe one or more GUIs 42 in each of the displays of a particular GUI 42.

Call center device 40 also includes one or more applications 44. Application 44 represents any suitable software or logic that allows a call center agent to view, access, analyze, and/or process a user's interactions with application 13 on mobile device 12. For example, application 44 may include a web application, a generic application, a routine application, a third-party application, a high-on-demand application, an application associated with a business unit, or any other future application types.

In an exemplary embodiment of operation, a user of mobile device 12 launches application 13 on mobile device 12 and begins interacting with application 13 during a session. When the application is launched, mobile device 12 and/or logging module 20 generates a unique identifier associated with the particular session. Mobile device 12 and/or logging module 20 also creates a log file in a database, and the log file is associated with the session. In an embodiment, the user interactions may be stored in the log file.

Depending on the mode of operation, mobile device 12 and/or logging module 20 may store the user interactions differently. For example, mobile device 12 and/or logging module 20 may operate in a passive mode of operation and in an active mode of operation.

In the passive mode, mobile device 12 and/or logging module 20 captures the user interactions during the session and stores the user interactions. Logging module 20 may store the user interactions as session data 30. In an embodiment, mobile device 12 may not communicate the user interactions to logging module 20 for storage until mobile device 12 has a Wireless Fidelity (“WiFi”) connection. When a call center agent desires to access the previously stored user interactions, call center device 40 communicates a request to logging module 20 to retrieve the stored user interactions. Logging module 20 determines the user interactions to communicate to call center device 40, reconstructs the user interactions for display on call center device 40, and communicates the reconstructed user interactions to call center device 40 for display.

In the active mode, a user initiates communication with a call center agent using application 13 on mobile device 12 during a session (or while a user is interacting with application 13). When the communication is initiated, mobile device 12 transmits the user interactions during the session and logging module 20 stores the user interactions as session data 30, determines the user interactions to communicate to call center device 40 in real time, reconstructs the user interactions to display on call center device 40, and communicates the reconstructed user interactions to call center device 40 for display. Logging module 20 communicates the reconstructed user interactions to call center device 40 in real time while the user interacts with application 13.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may include any number of mobile devices 12, base stations 14, gateways 16, networks 18, logging module 20, and call center devices 40. As another example, particular functions of logging module 20 may be performed by application 13 in mobile device 12. In this example, application 13 may capture the user interactions and communicate the user interactions to logging module 20 for storage and retrieval by call center device 40. Any suitable logic may perform the functions of system 10 and the components within system 10.

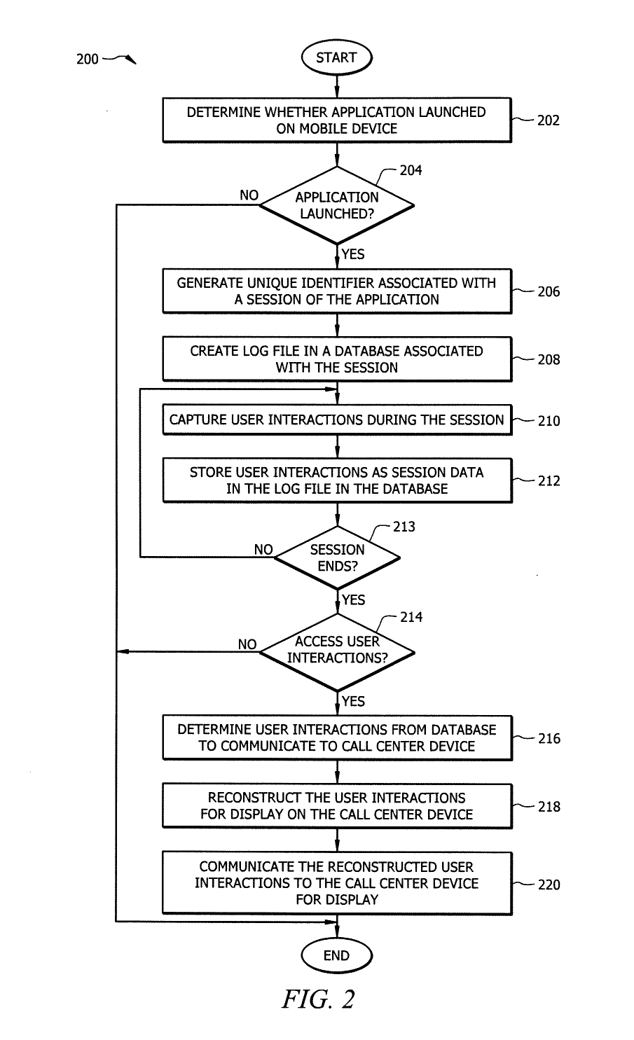

FIG. 2 illustrates an example flowchart 200 for facilitating communication between a mobile device and a call center in a passive mode. At step 202, logging module 20 determines whether a user launches application 13 on mobile device 12. If it is determined that application 13 is not launched at step 204, the method ends. If application 13 has been launched, the method continues from step 206.

At step 206, logging module 20 generates a unique identifier associated with a session of application 13. When a user launches application 13, that initiates a session for which logging module 20 generates and associates the unique identifier. Each time a user launches application 13, a new session begins and another unique identifier is associated with the session. At step 208, logging module 20 creates a log file in a database associated with the session. The information from the session may be stored as session data 30 in the log file.

At step 210, logging module 20 captures the user interactions with application 13 during the session and associates the user interactions with the unique identifier. To capture the data, logging module 20 receives the user interactions from mobile device 12. The user interactions may be transmitted via plain text using any suitable transmission technique, such as JavaScript Object Notation (“JSON”), Extensible Markup Language (“XML”), or other standard lightweight mobile transmission technique. In an embodiment, mobile device 12 may securely transfer the interactions using Hypertext Transfer Protocol Secure or data encryption.

The user interactions are stored as session data 30 in the log file in the database in step 212. Logging module 20 stores session data 30 as raw data, in JSON format, in XML format, as an image or screenshot, or in any other suitable format. Additionally, logging module 20 may capture and store certain portions of the display of application 13 or certain fields of application 13. In this embodiment, logging module 20 implements control logic that dictates what portion of application 13 to capture and store as session data 30. Logging module 20 determines whether the session ends at step 213. If the session does not end, the method proceeds from step 210 and logging module 20 continues to capture user interactions during the session and store the user interactions at step 212. If the session ends, the method proceeds from step 214.

At step 214, logging module 20 determines whether to access the stored user interactions. For example, logging module 20 may receive a request from call center device 40 to retrieve user interactions over a certain time period. As another example, logging module 20 may receive a request from call center device 40 to retrieve user interactions associated with a specific user. In an embodiment, a call center agent may review the interactions and proactively work to improve the user's interactions with application 13 by following up with the user, updating application 13, or other suitable technique. In this passive mode, call center device 40 does not receive the user interactions during the session.

At step 216, logging module 20 determines the user interactions from the database to communicate to call center device 40. Logging module 20 may determine the user interactions to communicate based on information in a request from call center device 40, pre-configured criteria, information received from an administrator, or any other suitable information. Additionally, logging module 20 may communicate specific screens associated with application 13 to call center devices 40. For example, call center device 40 may request information regarding user interactions with the account activity screen of application 13, a sign-in screen, a transfer funds screen, a bill pay screen, or any other suitable screen of application 13. Logging module 20 may determine the user interactions that meet the criteria. To determine which user interactions to communicate, logging module 20 may identify the user interactions based on the unique session identifier, the time of day, an identifier associated with the user (such as an account number or an on-line banking identifier), or any other suitable identification.

At step 218, logging module 20 reconstructs the user interactions for display on call center device 40. As discussed above, the user interactions may be stored as raw data. Logging module 20 translates the raw data into a format that is appropriate for display on call center device 40. In an embodiment, logging module 20 reconstructs the user interactions to mirror application 13 as shown to the user during the session. At step 220, logging module 20 communicates the reconstructed user interactions to call center device 40 for display. A call center agent may review and analyze the user interactions on call center device 40 to improve application 13, improve user interactions with application 13, troubleshoot application 13, provide guidance to a user of application 13, or any other suitable action that improves the effectiveness and efficiency of application 13 and a user's interactions with application 13. The method will subsequently end.

Modifications, additions, or omissions may be made to flowchart 200 depicted in FIG. 2. The method may include more, fewer, or other steps. For example, steps may be performed in parallel or in any suitable order. While discussed as logging module 20 performing the steps, any suitable component of system 10 may perform one or more steps of the method. For example, mobile device 12 may generate a unique identifier associated with the session, create a log file in which to store the user interactions, capture the user interactions during the session, and store the user interactions in local storage. Mobile device 12 may then communicate the stored user interactions to logging module 20 for storage and later retrieval by call center device 40. Mobile device 12 may communicate the stored interactions at any suitable time, such as at pre-determined intervals, at a pre-determined time period, or when mobile device 12 has a WiFi connection.

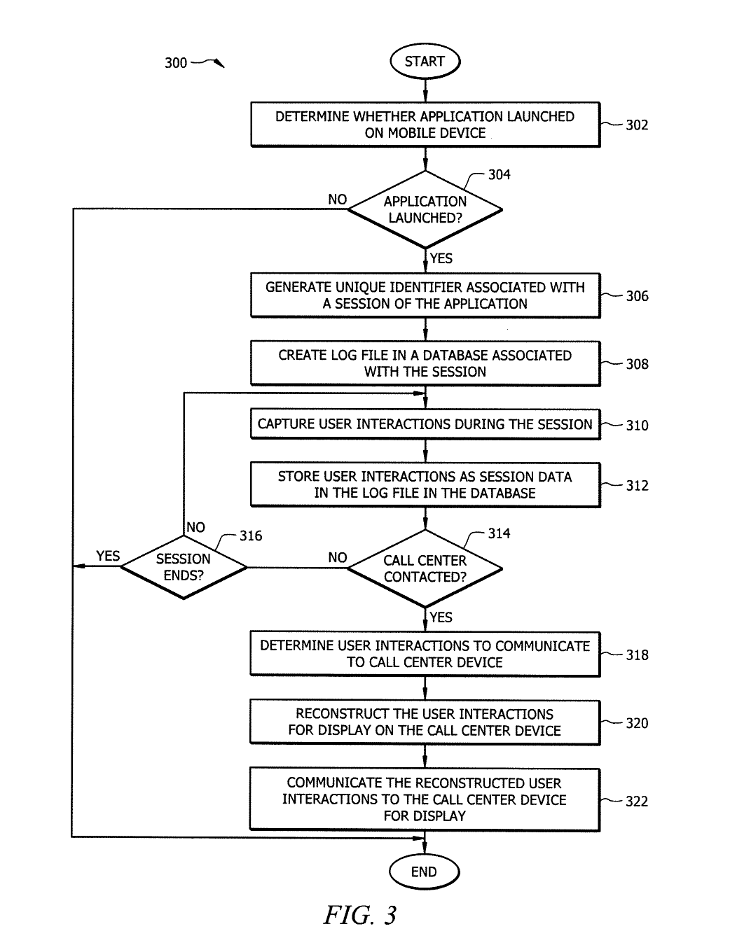

FIG. 3 illustrates an example flowchart 300 for facilitating communication between a mobile device and a call center in an active mode. At step 302, logging module 20 determines whether a user launches application 13 on mobile device 12. If it is determined that application 13 is not launched at step 304, the method ends. If application 13 has been launched at step 304, the method continues from step 306.

At step 306, logging module 20 generates a unique identifier associated with a session of application 13. When a user launches application 13, that initiates a session for which logging module 20 generates and associates the unique identifier. Each time a user launches application 13, a new session begins and another unique identifier is associated with the session. At step 308, logging module 20 creates a log file in a database associated with the session. The information from the session may be stored as session data 30 in the log file.

At step 310, logging module 20 captures the user interactions with application 13 during the session and associates the user interactions with the unique identifier. To capture the data, logging module 20 receives the user interactions from mobile device 12. The user interactions may be transmitted via plain text using any suitable transmission technique, such as JSON, XML, or other standard lightweight mobile transmission technique. In an embodiment, mobile device 12 may securely transfer the interactions using Hypertext Transfer Protocol Secure or data encryption.

The user interactions are stored as session data 30 in the log file in the database in step 312. Logging module 20 stores session data 30 as raw data, in JSON format, in XML format, as an image or screenshot, or in any other suitable format. Additionally, logging module 20 may capture and store certain portions of the display of application 13 or certain fields of application 13. In this embodiment, logging module 20 implements control logic that dictates what portion of application 13 to capture and store as session data 30.

At step 314, logging module 20 determines whether a user attempts to contact call center devices 40. For example, a user may access a help screen in application 13 and contacts call center devices 40 through the help screen. If the user does not contact call center devices 40, logging module 20 determines whether the session ends at step 316. If the session ends, the method disclosed in flowchart 300 terminates. If the session does not end, the method proceeds from step 310 and logging module 20 continues to capture user interactions during the session and store the user interactions at step 312.

If logging module 20 determines that a user has attempted to contact call center devices 40, the method proceeds to step 318. At step 318, logging module 20 determines the user interactions to communicate to call center device 40. Logging module 20 may determine the user interactions to communicate based on information in the request from mobile device 12 to call center device 40, pre-configured criteria, information received from an administrator, or any other suitable information. Additionally, logging module 20 may communicate specific screens associated with application 13 to call center devices 40. For example, call center device 40 may request information regarding user interactions with the account activity screen of application 13, a sign-in screen, a transfer funds screen, a bill pay screen, or any other suitable screen of application 13. Logging module 20 may determine the user interactions that meet the criteria. To determine which user interactions to communicate, logging module 20 may identify the user interactions based on the unique session identifier, the time of day, an identifier associated with the user (such as an account number or an on-line banking identifier), or any other suitable identification.

At step 320, logging module 20 reconstructs the user interactions for display on call center device 40. As discussed above, the user interactions may be stored as raw data. Logging module 20 translates the raw data into a format that is appropriate for display on call center device 40. In an embodiment, logging module 20 reconstructs the user interactions to mirror application 13 as shown to the user during the session. At step 322, logging module 20 communicates the reconstructed user interactions to call center device 40 for display. A call center agent may review and analyze the user interactions on call center device 40 to provide guidance to a user of application 13 during the user's session on application 13. In the active mode embodiment, logging module 20 will determine the user interactions, reconstruct the user interactions for display, and communicate the reconstructed user interaction for display in real time or near real time. This allows a call center agent to view the same information as a user interacting with application 13 while providing support services for application 13. The method will subsequently end.

Modifications, additions, or omissions may be made to flowchart 300 depicted in FIG. 3. The method may include more, fewer, or other steps. For example, steps may be performed in parallel or in any suitable order. While discussed as logging module 20 performing the steps, any suitable component of system 10 may perform one or more steps of the method. For example, mobile device 12 may generate a unique identifier associated with the session, create a log file in which to store the user interactions, capture the user interactions during the session, and store the user interactions in a log file. Mobile device 12 may then communicate the stored user interactions to logging module 20 in real-time or near real-time for communication to call center device 40.

Certain embodiments of the present disclosure may provide one or more technical advantages. A technical advantage of one embodiment includes gathering data regarding a customer's usage of a mobile application to determine potential issues the customer may encounter and proactively engage with the customer to remedy the issue. Another technical advantage of an embodiment includes providing an active view of the customer's interactions with a mobile application to a call center agent with during a support session. By providing the active view to the call center agent during the session, the call center agent is able to more readily appreciate the customer's issue and determine an appropriate resolution. Yet another technical advantage of an embodiment includes configuring the system to log only certain portions of information related to the user interactions.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An apparatus, comprising
a processor operable to:
determine whether an application is launched on a mobile device, wherein the application is stored locally on the mobile device;
generate, when the application is launched on the mobile device, a unique identifier associated with a session of the application launched on the mobile device;
capture user interactions with the application during the session; and
associate the user interactions with the unique identifier.

2. The apparatus of claim 1, wherein the processor is further operable to create a log file associated with the session in a database, and further comprising a memory communicatively coupled to the processor and the memory is operable to store the user interactions with the application during the session.

3. The apparatus of claim 1, wherein the processor is further operable to:
determine whether the session ends;
when the session ends, determine user interactions to communicate to a call center device;
reconstruct the user interactions with the application for display on the call center device, and further comprising an interface communicatively coupled to the processor and the interface is operable to communicate the reconstructed user interactions to the call center device for display.

4. The apparatus of claim 1, wherein the processor is further operable to:
determine whether a call center is contacted during the session;
when the call center is contacted during the session, determine user interactions to communicate to a call center device;
reconstruct the user interactions with the application for display on the call center device, and further comprising an interface communicatively coupled to the processor and the interface is operable to communicate the reconstructed user interactions to the call center device for display.

5. The apparatus of claim 4, wherein the processor is further operable to communicate the reconstructed user interactions to the call center device for display in real-time.

6. The apparatus of claim 4, wherein the processor is further operable to format the user interactions for display on the call center device.

7. The apparatus of claim 1, wherein the application is a selected one of a native application and a hybrid application.

8. Non-transitory computer readable medium comprising logic, the logic, when executed by a processor, operable to:
determine whether an application is launched on a mobile device, wherein the application is stored locally on the mobile device;
generate, when the application is launched on the mobile device, a unique identifier associated with a session of the application launched on the mobile device;
capture user interactions with the application during the session; and
associate the user interactions with the unique identifier.

9. The computer readable medium of claim 8, wherein the logic is further operable to:
create a log file associated with the session in a database; and
store the user interactions with the application during the session.

10. The computer readable medium of claim 8, wherein the logic is further operable to:
determine whether the session ends;
when the session ends, determine user interactions to communicate to a call center device;
reconstruct the user interactions with the application for display on the call center device; and
communicate the reconstructed user interactions to the call center device for display.

11. The computer readable medium of claim 8, wherein the logic is further operable to:
determine whether a call center is contacted during the session;
when the call center is contacted during the session, determine user interactions to communicate to a call center device;
reconstruct the user interactions with the application for display on the call center device; and
communicate the reconstructed user interactions to the call center device for display.

12. The computer readable medium of claim 11, wherein communicating the reconstructed user interactions to the call center device for display comprises communicating the reconstructed user interactions to the call center device for display in real-time.

13. The computer readable medium of claim 11, wherein reconstructing the user interactions with the application comprises formatting the user interactions for display on the call center device.

14. A method, comprising:
determining, by a processor, whether an application is launched on a mobile device, wherein the application is stored locally on the mobile device;
generating, by the processor and when the application is launched on the mobile device, a unique identifier associated with a session of the application launched on the mobile device;
capturing, by the processor, user interactions with the application during the session; and
associating, by the processor, the user interactions with the unique identifier.

15. The method of claim 14, further comprising:
creating, by the processor, a log file associated with the session in a database; and
storing, in the log file, the user interactions with the application during the session.

16. The method of claim 14, further comprising:
determining whether the session ends;
when the session ends, determining user interactions to communicate to a call center device;
reconstructing the user interactions with the application for display on the call center device; and
communicating the reconstructed user interactions to the call center device for display.

17. The method of claim 14, further comprising:
determining whether a call center is contacted during the session;
when the call center is contacted during the session, determining user interactions to communicate to a call center device;
reconstructing the user interactions with the application for display on the call center device; and
communicating the reconstructed user interactions to the call center device for display.

18. The method of claim 17, wherein communicating the reconstructed user interactions to the call center device for display comprises communicating the reconstructed user interactions to the call center device for display in real-time.

19. The method of claim 17, wherein reconstructing the user interactions with the application comprises formatting the user interactions for display on the call center device.

20. The method of claim 14, wherein the application is a selected one of a native application and a hybrid application.
